(19) United States
(12) Patent Application Publication
(10) Pub. No.: US 2026/0100664 A1
(43) Pub. Date: Apr. 9, 2026

(54) 6-STEP/LINEAR MODULATION HYBRID CONTROL METHOD

(71) Applicants: HYUNDAI MOTOR COMPANY, Seoul (KR); KIA CORPORATION, Seoul (KR)

(72) Inventor: Min Ho Chae, Hwaseong-si (KR)

(73) Assignees: HYUNDAI MOTOR COMPANY, Seoul (KR); KIA CORPORATION, Seoul (KR)

(21) Appl. No.: 19/255,302

(22) Filed: Jun. 30, 2025

(30) Foreign Application Priority Data
Oct. 8, 2024 (KR) 10-2024-0136194

(51) Int. Cl. H02P 23/04; B60L 15/20; H02P 23/14; H02P 27/12; H02P 27/14

(52) U.S. Cl. CPC H02P 23/04; B60L 15/2045; H02P 23/14; H02P 27/12; H02P 27/14

(57) ABSTRACT

A 6-step/linear modulation hybrid control method includes: inputting an acceleration signal through an input unit; calculating, by a controller, a required torque corresponding to the acceleration signal received from the input unit; determining, by the controller, whether or not the calculated required torque exceeds a predetermined torque; applying, by the controller, a hybrid modulation signal for execution of 6-step control and linear modulation control to a driver when the calculated required torque exceeds the predetermined torque; and performing, by the driver, the 6-step control for 3 phases among 6 phases of a stator winding of a motor while performing, by the driver, the linear modulation control for remaining 3 phases when the hybrid modulation signal is applied to the driver.

### CROSS-REFERENCE TO RELATED APPLICATION

This application claims priority, under 35 U.S.C. § 119(a), to Korean Patent Application No. 10-2024-0136194 filed on Oct. 8, 2024, the entire contents of which are incorporated herein by reference.

### BACKGROUND

### (a) Technical Field

The present disclosure relates to the field of motor control, and provides a hybrid control method in which, for control of a 6-phase motor, 6-step control is applied to 3 phases, and linear modulation control is applied to the remaining 3 phases, thereby being capable of reducing noise and vibration possibly generated in 6-step control and achieving control in a wider range, as compared to a conventional 6-step control method.

### (b) Background Art

The statements in this section merely provide background information related to the present disclosure and may not constitute prior art.

Motor control technologies are essential for optimization of performance of electric motors, and various control methods are known. Among these control methods, multi-phase motor control has importance particularly in association with high-performance applications. A multi-phase motor provides high reliability and high efficiency, and the control method thereof may be determined in accordance with an ability thereof to manage speed and torque of the motor.

In addition, for multi-phase motor control, a technology for optimizing operation characteristics of a motor by adopting one of a switching method and a linear modulation control method is used. Through such a control method, it may be possible to maximize performance of the motor and to secure stable driving of the motor under various operation conditions.

The conventional 6-step control method has been widely used as a relatively simple and efficient control method for multi-phase motors. This method has advantages in that, as a rotor of a motor is driven at intervals of a predetermined time, a stable torque output is provided, switching loss is small, and implementation of the method is easy. In addition, reliability may be maintained even in a high-speed rotation situation and, as such, this method is adopted in various industrial fields. Since this method is easily applicable through utilization of an existing control device and an existing inverter, the method has been settled upon as a cost-efficient and reliable solution.

However, the 6-step control method has drawbacks in that problems of vibration and noise generated at a particular frequency, that is, noise, vibration, and harshness (NVH) problems, may occur. In particular, during low-speed driving, the control performance of the motor may be insufficient. Furthermore, vibration and noise generated in a particular frequency band may degrade reliability of the system. In addition, when the 6-phase motor is completely controlled by the 6-step control method, a controllable range thereof is limited and, as such, it may be difficult to utilize the performance of the motor.

In order to overcome such limitation of the above-described conventional technology, research is being conducted in order to enhance control performance of a motor through combination of various control methods. In particular, it is desired to conduct research on a hybrid control method capable of providing a wide control range while eliminating NVH problems through combination of a 6-step control method and a linear modulation control method. Through such a hybrid control method, stable and efficient motor control at both low speed and high speed may be realized.

### SUMMARY

The present disclosure has been made in an effort to solve the above-described problems associated with the prior art, and an object of the present disclosure is to provide a hybrid control method in which, for control of a 6-phase motor, 6-step control is applied to 3 phases, and linear modulation control is applied to the remaining 3 phases, thereby being capable of reducing noise, vibration, and harshness (NVH) problems caused by 6-step control while optimizing performance of the motor in a wider control range.

Another object of the present disclosure is to provide stable motor control even during high-speed and high-load driving.

Objects of the present disclosure are not limited to the above-described objects, and other objects of the present disclosure not yet described should be more clearly understood by those having ordinary skill in the art from the following detailed description. In addition, objects of the present disclosure may be accomplished by means defined in the appended claims and combinations thereof.

A 6-step/linear modulation hybrid control method configured to accomplish the above-described objects of the present disclosure is constituted by the following configurations.

In one aspect, the present disclosure provides a 6-step/linear modulation hybrid control method. The 6-step/linear modulation hybrid control method includes: inputting an acceleration signal through an input unit; calculating, by a controller, a required torque corresponding to the acceleration signal input by the user; determining, by the controller, whether or not the calculated required torque exceeds a predetermined torque; upon determining that the calculated required torque exceeds the predetermined torque, applying, by the controller, a hybrid modulation signal for execution of 6-step control and linear modulation control to a driver; and performing, by the driver, the 6-step control for 3 phases among 6 phases of a stator winding of a motor while performing, by the driver, the linear modulation control for remaining 3 phases when the hybrid modulation signal is applied to the driver.

In an embodiment, calculating the required torque may include: calculating, by the controller, an acceleration and a target speed in accordance with a variation rate of the acceleration signal input from the input unit; and calculating the required torque based on the calculated acceleration and the calculated target speed.

In another embodiment, the predetermined torque may include a half of an outputtable maximum torque, corresponding to a speed.

In still another embodiment, in applying the hybrid modulation signal for execution of 6-step control and the linear modulation control to the driver when the calculated required torque exceeds the predetermined torque, the controller may apply, to the driver, current corresponding to the 6-step control for the 3 phases among the 6 phases, and may apply, to the driver, current corresponding to the linear modulation for the remaining 3 phases.

In yet another embodiment, performing the 6-step control for 3 phases while performing the linear modulation control for remaining 3 phases may include performing, by the driver, switching a voltage of each of the 3 phases at intervals of a particular time in the 6-step control in order to apply a 3-phase voltage to each of the 3 phases.

In yet another embodiment, performing switching a voltage of each of the 3 phases may include applying, by the driver, a voltage to only two of the 3 phases using the switched voltage while maintaining, by the driver, a remaining one of the 3 phases in an OFF state. The applying the voltages to the two of the 3 phases using the switched voltage while maintaining the remaining one of the 3 phases in the OFF state may include sequentially changing, by the driver, ones of the 3 phases, to which the voltage is applied, through an inverter, thereby generating, by the driver, a rotating magnetic field of the motor. In one embodiment, generating the rotating magnetic field of the motor may include rotating, by the driver, a rotor of the motor through the generated magnetic field.

In yet another embodiment, performing the 6-step control for 3 phases among 6 phases while performing the linear modulation control for the remaining 3 phases may include performing, by the driver, Clarke transform in the linear modulation control in order to represent a 3-phase voltage as a 2-dimensional vector.

In another further embodiment, performing the Clarke transform in the linear modulation control may include determining, by the driver, a sector, in which vectors are disposed in a space-vector plane, based on the Clarke-transformed 2-dimensional space vectors, and selecting, by the driver, two fixed vectors and a zero vector from the sector in which the vectors are disposed in a space-vector plane, thereby creating a voltage vector.

In another further embodiment, selecting the two fixed vectors and the zero vector from the determined sector may include calculating, by the driver, switching times of the two fixed vectors and the zero vector based on the created voltage vector; generating, by the driver, a pulse width modulation signal in accordance with the calculated switching times, thereby controlling the inverter; and controlling, by the inverter, a voltage of the motor using the generated pulse width modulation signal.

In yet another further embodiment, the 6-step/linear modulation hybrid control method further includes: upon determining that the calculated required torque does not exceed the predetermined torque, applying, by the controller, a signal to the driver to control the driver to perform linear modulation control for all 6 phases of the stator winding of the motor.

In still yet another further embodiment, in performing the 6-step control for 3 phases while performing the linear modulation control for the remaining 3 phases when the hybrid modulation signal is applied to the driver, the driver may output a maximum torque through execution of the 6-step control for the 3 phases among the 6 phases in order to satisfy the required torque, and may then perform the linear modulation control for the remaining 3 phases, corresponding to a difference between the output maximum torque and the calculated required torque.

Other aspects and embodiments of the present disclosure are discussed below.

The above and other features of the present disclosure are discussed below.

### BRIEF DESCRIPTION OF THE DRAWINGS

The above and other features of the present disclosure are now described in detail with reference to certain embodiments thereof illustrated in the accompanying drawings which are given hereinbelow by way of illustration only, and thus are not limitative of the present disclosure, and wherein:

FIG. 1 shows a configuration of a motor control apparatus for 6-step/linear modulation hybrid control according to an embodiment of the present disclosure;

FIG. 2 shows the case in which 6-step control is applied to 3 phases among 6 phases and linear modulation control is applied to the remaining 3 phases in accordance with an embodiment of the present disclosure;

FIG. 3 shows a zone of a torque-speed graph in which 6-step control is possible, in accordance with an embodiment of the present disclosure;

FIG. 4 shows a schematic flowchart of 6-step/linear modulation hybrid control according to an embodiment of the present disclosure;

FIG. 5A shows a flowchart of 6-step control applied to 3 phases among 6 phases in accordance with an embodiment of the present disclosure in detail; and

FIG. 5B shows a flowchart of linear modulation control for 3 phases among 6 phases according to an embodiment of the present disclosure in detail.

It should be understood that the appended drawings are not necessarily to scale, presenting a somewhat simplified representation of various features illustrative of the basic principles of the present disclosure. The specific design features of the present disclosure as disclosed herein, including, for example, specific dimensions, orientations, locations, and shapes should be determined in part by the particular intended application and use environment.

In the figures, reference numbers refer to the same or equivalent parts of the present disclosure throughout the several figures of the drawing.

### DETAILED DESCRIPTION

Hereinafter, embodiments of the present disclosure are described in detail with reference to the annexed drawings. However, the embodiments may be modified in various ways and the scope of the embodiments should not be construed as being limited to the following embodiments. Thus, the embodiments are provided to ensure more perfect comprehension of the embodiments by one of ordinary skill in the art.

In addition, the term “part”, “unit”, or the like described in the specification means a unit for processing at least one function or operation, and this unit may be implemented by hardware, software, or a combination thereof.

Although terms in the specification are used to describe particular embodiments, and are not intended to limit the embodiments. Unless clearly used otherwise, singular expressions include a plural meaning.

When a part is described as “including” a constituent element throughout the specification, this means that another constituent element may be further included, without exclusion of the other constituent element, unless referred to the contrary. In addition, the term “ . . . unit” or the like described in the specification means the unit of processing at least two functions or operations.

When a component, device, element, or the like of the present disclosure is described as having a purpose or performing an operation, function, or the like, the component, device, or element should be considered herein as being “configured to” meet that purpose or to perform that operation or function.

In addition, a controller 20 may be implemented by an algorithm configured to control operation of various constituent elements disposed in a vehicle, a memory configured to store data of a program reproducing the algorithm, or a processor configured to execute the above-described operation using the data stored in the memory. In this case, the memory and the processor may be embodied as individual chips, respectively. Alternatively, the memory and the processor may be embodied as a single chip. For example, the controller 20 may be configured through inclusion of at least two of a central processing unit (CPU), a microprocessor unit (MPU), a microcontroller unit (MCU), an application processor (AP), or a processor of any type well-known in the technical field of the present disclosure.

In addition, the controller 20 may be configured through a combination of software and hardware capable of performing calculation for at least two applications or programs configured to execute a method according to embodiments of the present disclosure.

In addition, in the following description, a required torque means rotation force required for a vehicle to be accelerated or to be maintained at a predetermined speed in accordance with an input from the user.

In addition, in the following description, linear modulation control means space-vector pulse width modulation (SVPWM).

Furthermore, a driver 30 means a motor control unit 31 or an electronic control unit (ECU).

Hereinafter, embodiments are described in detail with reference to the accompanying drawings. In the description given with reference to the accompanying drawings, identical or corresponding constituent elements are designated by the same reference numeral, and overlapping description thereof has been omitted.

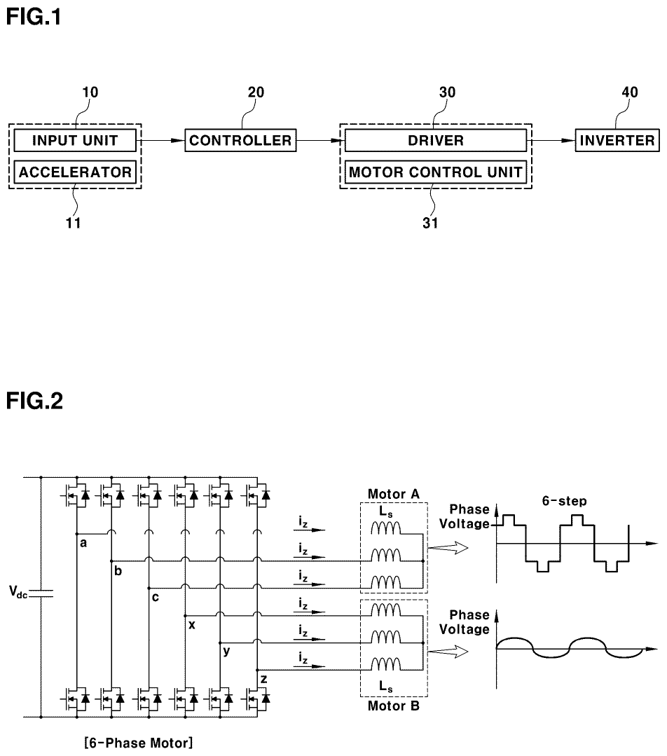

FIG. 1 shows a configuration of a motor control apparatus for 6-step/linear modulation hybrid control.

In an embodiment of the present disclosure, the motor control apparatus may include: an input unit 10 including an accelerator 11 configured to receive an acceleration signal from the user, and a controller 20 configured to process the acceleration signal received from the input unit 10, thereby controlling a rotation speed and a torque of a motor. The motor control apparatus also includes: a driver 30 configured to drive the motor in accordance with a control signal from the controller 20, and an inverter 40 configured to perform voltage conversion in accordance with a signal from the driver 30, thereby supplying electric power to the motor. The above-described constituent elements are interconnected and interact with one another to control the motor.

In addition, the input unit 10 performs a function of receiving a signal from the accelerator 11 used by the user to control acceleration of a vehicle. The accelerator 11 may include an accelerator pedal, a throttle-by-wire system, a hand controller, etc., and such devices operate to generate an acceleration signal in accordance with an intention of the user.

For example, the accelerator pedal generates an electrical signal in accordance with a depressed degree of the accelerator pedal by a foot of the user, and the throttle-by-wire system electronically controls the electrical signal, thereby determining a torque to be transmitted to an engine or the motor. Furthermore, the input unit 10 receives the electrical signal, and then transmits the received electrical signal to the controller 20 to provide basic data required for power control of the vehicle.

The controller 20 performs a function of determining a motor control method of the vehicle based on the acceleration signal received from the input unit 10. In detail, the controller 20 analyzes the signal input thereto and calculates an acceleration and a target speed required by the user.

For this function, the controller 20 measures a variation rate of the input signal, and calculates a current acceleration state of the vehicle and a required torque required for the speed of the vehicle to reach the target speed, based on the measured variation rate.

In addition, the controller 20 determines whether or not the calculated required torque exceeds a torque stored in the controller 20. When the calculated required torque exceeds the torque stored in the controller 20, the controller 20 applies a signal for control of the driver 30.

Furthermore, in the above-described procedure, the controller 20 generates a hybrid modulation signal for combination control of 6-step control and linear modulation control, and transmits the hybrid modulation signal to the driver 30.

In another embodiment, the controller 20 may be configured to directly apply, to the driver 30, current according to 6-step control and current according to linear modulation control, differently from the above-described embodiment in which the controller 20 generates a hybrid control signal, and then transmits the hybrid control signal to the driver 30.

In addition, the driver 30 may be configured to receive the hybrid control signal sent from the controller 20 and to apply a desired signal to the inverter 40 for motor control, or may be configured to apply, by itself, current corresponding to hybrid control to a stator winding, thereby controlling a rotation speed and rotation force of the motor.

In detail, the driver 30 performs 6-step control for 3 phases among 6 phases, and performs linear modulation control for the remaining 3 phases. In the 6-step control, a voltage of each phase is switched at intervals of a particular time to generate a rotating magnetic field, thereby moving a rotor.

On the other hand, the linear modulation control enables precise motor control and, as such, driving stability of the vehicle is maintained through the precise motor control. The driver 30 achieves optimal motor performance in various driving situations through combination of the above-described two control methods.

In addition, the inverter 40 performs voltage conversion in accordance with a control signal from the driver 30, thereby performing a function of supplying suitable electric power to the motor. The inverter 40 controls a voltage transmitted to the motor, based on a pulse width modulation signal generated from the driver 30, thereby optimizing a rotation speed and a torque of the motor.

Furthermore, the inverter 40 is configured to efficiently convert electrical energy and to supply the converted energy to the motor, thereby enabling the vehicle to realize stable acceleration in accordance with an acceleration input from the user.

As apparent from the above description, the motor control apparatus is configured to widen the control range of the motor of the vehicle through close interaction among the constituent elements thereof and to efficiently implement the 6-step/linear modulation hybrid control method.

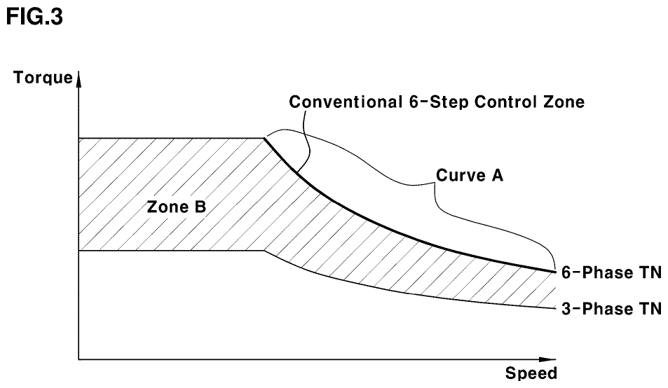

FIG. 2 shows the case in which 6-step control is applied to 3 phases among 6 phases, and linear modulation control is applied to the remaining 3 phases.

In an embodiment of the present disclosure, the motor control apparatus is configured to apply different control methods to two groups of 3 phases, respectively, based on a 6-phase motor structure. As shown in FIG. 2, the two phase groups, for which different control operations are performed, based on a single motor assembly, may be described under the condition that the two phase groups are distinguished into a motor A and a motor B, respectively.

As shown in FIG. 2, the motor A applies the 6-step control method to the 3 phases thereof among the 6 phases, and the motor B applies the linear modulation control method to the remaining 3 phases thereof. Through such control methods, the motor A and the motor B may achieve optimal control thereof under various driving conditions through utilization of advantages of respective control methods.

For example, in a situation in which a torque required upon acceleration of the vehicle is 200 Nm, the maximum torque of the 6-phase motor may be 300 Nm. The motor A outputs a maximum torque of 150 Nm through the 6-step control method, and the motor B generates a remaining torque of 50 Nm through the linear modulation control method and, as such, satisfies a required torque of 200 Nm on the whole.

Furthermore, the above-described control method, which are divided into two control methods for the motor A and the motor B, optimizes performance of the motor through combination of the two control methods. The motor A provides a higher torque than a torque output by the motor B, through the 6-step control method, and the motor B performs precise torque control through the linear modulation control method. As such, it may be possible to cope with various driving conditions required by the vehicle while minimizing noise, vibration, harshness (NVH) problems.

In addition, each of the motor A and motor B generates a rotating magnetic field through control of a voltage at each phase thereof, thereby causing the rotor of the motor to move. The 6-step control method causes the motor to generate rotation force by switching the voltage at intervals of a particular time, whereas the linear modulation control method provides stable rotation force by precisely adjusting the voltage.

The 6-step/linear modulation hybrid control method of the present disclosure controls the 6-phase motor structure by dividing the 6 phases into two groups of 3 phases such that the 6-phase motor structure is divided into the motor A and the motor B. This control method efficiently provides a required torque while reducing vibration and noise problems under various driving conditions.

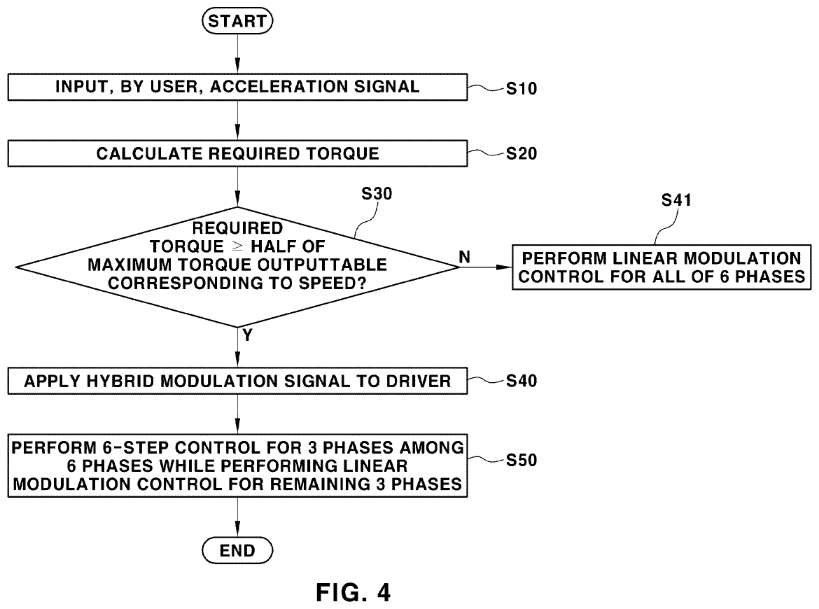

FIG. 3 shows a zone of a T-N graph in which 6-step control is possible.

FIG. 3 shows a T-N graph depicting a relation between torque and speed when, in a 6-phase motor control method, a combination of 6-step control and linear modulation control is used. This curve visually shows speed zones to which the two control methods are applied, respectively.

In the graph depicted in FIG. 3, a curve A shows a controllable zone when only the 6-step control is applied. On this curve, the 6-step control is applied to all phases of the 6-phase motor. Furthermore, the curve A corresponds to a constant-power curve for constant power.

Basically, the 6-phase motor performs linear modulation control until maximum power is generated, and 6-step control is then applied to all phases of the 6-phase motor when the output of the 6-phase motor reaches the maximum power.

Accordingly, when 6-step control is applied to all phases of the 6-phase motor, the torque curve generated as the speed of the 6-phase motor increases in order to generate constant maximum power takes the form of a right downward sloping curve.

In addition, a zone B represents a zone in which combination control through combination of 6-step control and linear modulation control is possible. In the zone B, the 6-step control method is applied to 3 phases among 6 phases, and an additional torque for generation of additional power may be obtained through the linear modulation control method applied to the remaining 3 phases, differently from the case in which the 6-step control is applied to all 6 phases. Accordingly, the 6-step control of three phases among 6 phases may be possible in a wider range, as compared to the case in which the 6-step control is applied to all 6 phases.

Consequently, in the present disclosure, the 6-step control zone is further expanded than a zone A in which 6-step control is applied to all of 6 phases in a conventional case and, as such, is varied form the zone A to the zone B. Accordingly, an operating point of the motor may be expanded.

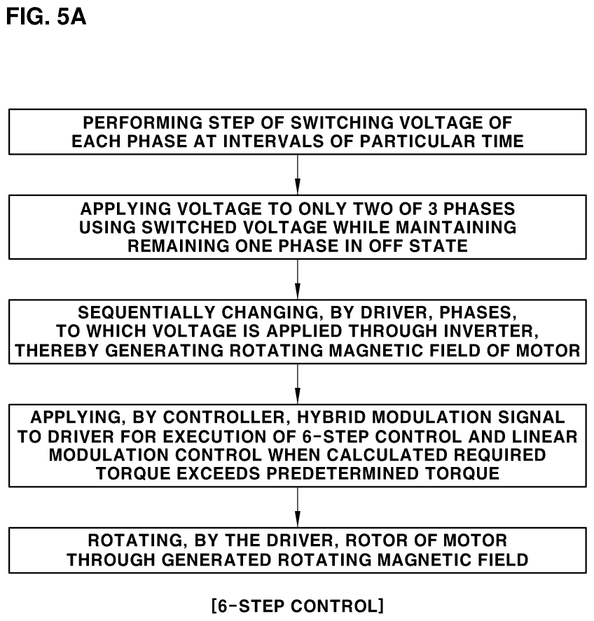

FIG. 4 shows a flowchart of 6-step/linear modulation hybrid control in in one embodiment of the present disclosure.

In an embodiment of the present disclosure, a 6-step/linear modulation hybrid control method is constituted by a series of steps of inputting, by the user, an acceleration signal through the input unit 10, and controlling, by the controller 20 and the driver 30, rotation force and a speed of the motor based on the acceleration signal.

First, a procedure of inputting, by the user, the acceleration signal through the input unit 10 is performed. The input unit 10 is constituted by an accelerator of the vehicle. The accelerator includes an accelerator pedal, a throttle-by-wire system, a hand controller, etc. When the user presses the accelerator pedal or manipulates a throttle, the pressed or manipulated device converts an input generated through the depression or manipulation thereof, that is, the acceleration signal, into an electrical signal, and then transmits the electrical signal to the controller 20 (in step S10).

Thereafter, the controller 20 performs the step of calculating a required torque of the vehicle based on the acceleration signal received from the input unit 10. The controller 20 analyzes a magnitude and a variation rate of the acceleration signal, thereby checking an acceleration intension of the user. In this procedure, the controller 20 identifies a current speed and a current acceleration of the vehicle, and calculates a required torque required for the current speed and the current acceleration to reach a target speed and a target acceleration. This calculation is carried out while taking into consideration the mass of the vehicle, the current driving situation, road conditions, other relevant factors as a whole. The calculated required torque represents a concrete torque value which should be generated by the motor, for acceleration or deceleration of the vehicle. This torque value is adjusted in real time.

Subsequently, the controller 20 performs a procedure of determining whether or not the required torque calculated in the step of calculating a required torque exceeds a predetermined torque stored in the controller 20, based on the calculated required torque. In this case, the predetermined torque stored in the controller 20 is defined by a half value of a maximum torque which may be generated, corresponding to the current speed of the vehicle (in step S20).

The controller 20 first calculates a maximum torque value based on the current speed of the vehicle, and reduces the calculated maximum torque value by half, thereby setting the resultant value as the predetermined torque stored in the controller 20. Thereafter, the controller 20 compares the calculated required torque with the predetermined torque stored in the controller 20, thereby determining whether or not the required torque exceeds the predetermined torque stored in the controller 20. When the required torque exceeds the predetermined torque, the controller changes a control method in the next step (in step S30).

When the calculated torque exceeds the predetermined torque stored in the controller 20, in the step of determining whether or not the calculated torque exceeds the predetermined torque stored in the controller 20, the controller 20 performs step of generating a hybrid modulation signal for execution of hybrid control of 6-step control and linear modulation control, and applying the hybrid modulation signal to the driver 30 (in step S40).

In the step S40, the controller 20 generates the hybrid modulation signal and, as such, applies 6-step control to 3 phases among 6 phases, and applies linear modulation control to the remaining 3 phases. The hybrid modulation signal is transmitted to the driver 30 to be used for control of rotation force of the motor.

In another embodiment, the controller 20 may control rotation of the motor by directly applying, to the driver 30, current according to the 6-step control for 3 phases among the 6 phases and current according to the linear modulation control for the remaining 3 phases.

Next, a procedure of performing, by the driver 30, 6-step control for 3 phases among the 6 phases of the motor while performing, by the driver 30, linear modulation control for the remaining 3 phases is executed, based on the hybrid modulation signal received from the controller 20. The driver 30 switches a voltage for the 3 phases, to which the 6-step control is applied, at intervals of a predetermined time, thereby generating a rotating magnetic field. In the switching procedure, the voltage is sequentially applied to respective 3 phases and, as such, a magnetic field rotates in the rotor. As a result, the motor generates a required torque and, as such, satisfies required rotation force.

When the hybrid modulation signal is applied to the driver 30, the driver 30 first performs 6-step control for 3 phases among the 6 phases, thereby enabling the output of a maximum torque achievable through the 6-step control. Subsequently, the driver 30 calculates a difference between the output maximum torque and the required torque, and then performs linear modulation control for the remaining 3 phases, corresponding to the difference between the maximum torque and the required torque, and, as such, complements the maximum torque output in the 6-step control, thereby satisfying the required torque (in step S50).

However, when the calculated torque does not exceed the predetermined torque stored in the controller 20, in the step of determining whether or not the calculated torque exceeds the predetermined torque stored in the controller 20, the controller 20 performs the step of applying a signal to the driver 30 to control the driver 30 to perform linear modulation control for all 6 phases (in step S41).

In other words, the 6-step/linear modulation hybrid control method of the present disclosure is constituted by a series of procedures of: calculating a required torque of the vehicle in accordance with an acceleration signal input by the user, and controlling rotation force of the motor by applying 6-step control to 3 phases among 6 phases while applying linear modulation control to the remaining 3 phases when the calculated required torque exceeds a predetermined torque limit, and applying linear modulation control to all 6 phases when the calculated required torque does not exceed the predetermined torque limit.

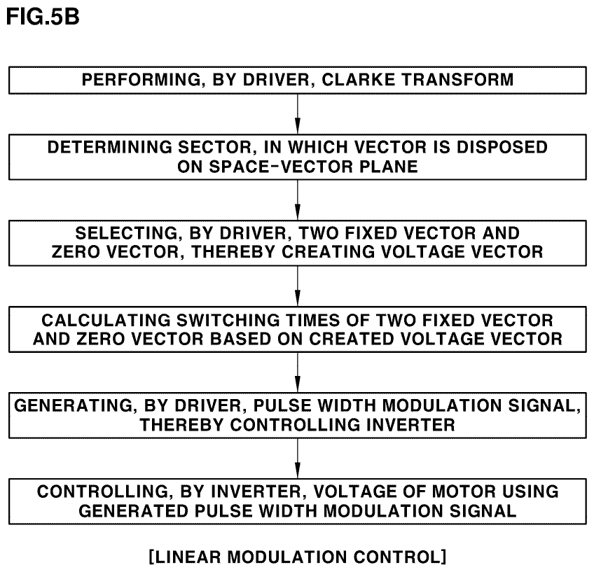

FIG. 5A shows a flowchart of 6-step control applied to 3 phases among 6 phases in an embodiment of the present disclosure.

In an embodiment of the present disclosure, the driver 30 performs 6-step control for 3 phases among 6 phases of the stator winding of the motor when the hybrid modulation signal is applied to the driver 30.

The driver 30 performs a step of switching a voltage of each phase at intervals of a particular time in the 6-step control. In this step, the driver 30 switches the voltage of each phase at intervals of a predetermined time in order to sequentially apply a voltage to the 3 phases among the 6 phases of the stator winding of the motor. “For example, for the three phases (i.e., phases A, B, and C), the driver 30 first applies a voltage to the phase A, switches the voltage to phase B after a predetermined period of time elapses, and then switches it to phase C after another predetermined period of time elapses. Such voltage switching is an initial step for formation of a rotating magnetic field in the motor.

Thereafter, the driver 30 performs, in the 6-step control, a step of applying a voltage only to two phases of the 3 phases using the voltage switched in the 6-step control while maintaining the remaining one phase in an OFF state. In this step, in the voltage-switched state, a voltage is applied to only the two phases, and the remaining one phase is maintained in an OFF state. For example, a voltage is applied to only the phase A and the phase B, and the phase C is maintained in an OFF state. This method is capable of providing a voltage required for driving of the motor while reducing power consumption.

Thereafter, the driver 30 performs a step of sequentially changing the phases, to which a voltage is applied, thereby generating a rotating magnetic field of the motor. In this procedure, the driver 30 sequentially changes the phases, to which a voltage is applied, through the inverter 40. For example, voltage switching is repeated in such a manner that application of the voltage is switched to the phase B and the phase C in a state in which a voltage has been applied to the phase A and the phase B, and is then again switched to the phase C and the phase A. Such sequential change causes generation of the rotating magnetic field of the motor and, as such, provides force capable of driving the rotor of the motor.

Finally, the driver performs a step of rotating the rotor of the motor through the generated rotating magnetic field. The rotating magnetic field generated by the driver 30 acts on the rotor of the motor, thereby inducing rotation of the rotor. By this rotation force, the motor is actually driven. For example, the rotating magnetic field generated as the driver 30 switches the voltage from the phase A to the phase B and then from the phase B to the phase C rotates the rotor in a predetermined direction.

As apparent from the above description, the 6-step control method for 3 phases among 6 phases is constituted by switching a voltage stepwise, applying the voltage, and sequentially generating a rotating magnetic field, thereby driving the motor.

FIG. 5B shows a flowchart of linear modulation control for 3 phases among 6 phases in one embodiment of the present disclosure.

An embodiment of the present disclosure provides a method of performing linear modulation control for 3 phases among 6 phases of the stator winding of the motor. Furthermore, the linear modulation control method includes procedures of calculating a voltage vector in a stepwise manner, and controlling a voltage of the motor based on the calculated voltage vector.

In detail, the driver 30 performs the step of executing Clarke transform in order to express a 3-phase voltage as a 2-dimensional vector. The Clarke transform is a mathematical transform procedure for expressing three phase voltages by vectors in an α-β space.

When a 2-dimensional vector is created through Clarke transform, the driver 30 performs a step of determining a sector, in which the vector is disposed, in a space-vector plane. In this step, a sector, in which the transformed 2-dimensional vector is located, in the α-β space is determined. For example, when the vector is disposed in a particular sector (for example, a first sector, a second sector, or the like), a combination of vectors to be used in the sector may be determined.

When the sector is determined, the driver 30 performs a step of selecting two fixed vectors and a zero vector in the determined sector, thereby creating a voltage vector. In this step, a target voltage vector is configured using two fixed vectors nearest to each other and a zero vector in the determined sector. For example, the two fixed vectors selected in the sector are vectors located at a corner of the sector, and the selected fixed vectors are combined with the zero vector, thereby creating the voltage vector.

Thereafter, the driver 30 performs a step of calculating switching times of the two fixed vectors and the zero vector based on the created voltage vector. In this case, the driver 30 calculates the specific times during which the fixed vectors and the zero vector should be applied to achieve the target voltage vector. For example, the two fixed vectors may be applied for times of 70% and 20%, respectively, and the zero vector may be applied for a time of 10%.

After calculating the switching times, the driver 30 performs a step of generating a pulse width modulation signal in accordance with the calculated switching times, thereby controlling the inverter 40. In this step, the pulse width modulation signal is generated through reflection of the calculated switching times, and the inverter 40 is controlled through the generated pulse width modulation signal. For example, a duty cycle of the pulse width modulation signal is determined in accordance with the switching times of the two fixed vectors and the zero vector, and is used to control the inverter 40. Here, the duty cycle means a rate of an ON-state time of a pulse in the pulse width modulation signal, and an average voltage applied to the motor rises as the duty cycle becomes higher.

Finally, the inverter 40 performs a step of controlling a voltage of the motor using the generated pulse width modulation signal. In this step, the inverter 40 controls the voltage applied to the motor in accordance with the pulse width modulation signal and, as such, driving of the motor is carried out. The magnitude and time of the applied voltage are adjusted in accordance with the duty cycle of the pulse width modulation signal, and are important factors for control of the speed and the torque of the motor.

Consequently, the linear modulation control method of the present disclosure is constituted by a method of transforming a 3-phase voltage into a 2-dimensional vector through the Clarke transform, determining a sector based on the 2-dimensional vector, and calculating switching times of two fixed vectors and a zero vector, thereby controlling a voltage of the motor. Such a control method achieves an enhancement in driving efficiency of the motor while enabling precise voltage control.

In summary, the present disclosure provides a hybrid control method of applying 6-step control to 3 phases among 6 phases while applying linear modulation control to the remaining 3 phases when a required torque exceeds a predetermined torque. In addition, the hybrid control method applies a voltage to each phase through switching during driving of the motor, and performs linear modulation control through Clarke transform. As such, in the present disclosure, a rotating magnetic field of the motor is generated, and rotation force of the motor is effectively controlled in accordance with predetermined conditions.

The present disclosure may obtain the following effects through the embodiments and the configurations as described above together with combinations and use relations thereof.

First, noise, vibration, and harshness (NVH) problems may be effectively reduced as 6-step control is applied to 3 phases among 6 phases, and linear modulation control is applied to the remaining 3 phases. Accordingly, an effect of enhancing ride comfort may be obtained through reduction in noise and vibration of a motor.

Second, through the hybrid control method, it may be possible to widen a control range of the motor and to enable precise torque control even during high-speed driving. Accordingly, an effect of optimizing performance of the motor under various driving conditions may be obtained.

Third, through combination of advantages of 6-step control and linear modulation control, effects of enhancing efficiency of the motor under high-speed and high-load conditions and reducing power consumption, thereby enhancing energy efficiency of the system on the whole, may be obtained.

The above detailed description illustrates the present disclosure. In addition, the above-described content is given to illustrate and describe embodiments of the present disclosure. The present disclosure may be used in various combinations, alterations, and environments. In other words, the present disclosure may be changed or modified within the scope of the concept of the present disclosure disclosed in the specification, the scope equivalent to the above-described content and/or the scope of technologies or knowledge in the technical field. The described embodiments are intended to describe a best state for realizing the technical idea of the present disclosure, and various changes required in concrete application fields and applications may be possible. Accordingly, the above detailed description of the present disclosure is not intended to limit the present disclosure to the disclosed implementation state. In addition, the annexed claims should be interpreted as also including other implementation states.

What is claimed is:

1. A 6-step/linear modulation hybrid control method comprising:
inputting an acceleration signal through an input unit;
calculating, by a controller, a required torque corresponding to the acceleration signal;
determining, by the controller, whether or not the calculated required torque exceeds a predetermined torque;
upon determining that the calculated required torque exceeds the predetermined torque, applying, by the controller, a hybrid modulation signal for execution of 6-step control and linear modulation control to a driver; and
performing, by the driver, the 6-step control for 3 phases among 6 phases of a stator winding of a motor while performing, by the driver, the linear modulation control for remaining 3 phases.

2. The 6-step/linear modulation hybrid control method according to claim 1, wherein calculating the required torque comprises:
calculating, by the controller, an acceleration and a target speed in accordance with a variation rate of the acceleration signal from the input unit, and
calculating the required torque based on the calculated acceleration and the calculated target speed.

3. The 6-step/linear modulation hybrid control method according to claim 1, wherein the predetermined torque comprises a half of an outputtable maximum torque, corresponding to a target speed.

4. The 6-step/linear modulation hybrid control method according to claim 1, wherein, in applying the hybrid modulation signal for execution of the 6-step control and the linear modulation control to the driver, the controller applies, to the driver, current corresponding to the 6-step control for the 3 phases among the 6 phases, and applies current corresponding to the linear modulation for the remaining 3 phases.

5. The 6-step/linear modulation hybrid control method according to claim 1, wherein performing the 6-step control for 3 phases while performing the linear modulation control for the remaining 3 phases comprises:
performing, by the driver, switching a voltage of each of the 3 phases at intervals of a particular time in the 6-step control in order to apply a 3-phase voltage to each of the 3 phases.

6. The 6-step/linear modulation hybrid control method according to claim 5, wherein:
performing switching respective voltages of the 3 phases comprises applying, by the driver, voltages to two of the 3 phases using the switched voltages, respectively, while maintaining, by the driver, a remaining one of the 3 phases in an OFF state;
applying the voltages to the two of the 3 phases using the switched voltages while maintaining the remaining one of the 3 phases in the OFF state comprises: sequentially changing, by the driver, ones of the 3 phases, to which voltages are applied, through an inverter, thereby generating, by the driver, a rotating magnetic field of the motor; and
generating the rotating magnetic field of the motor comprises rotating, by the driver, a rotor of the motor through the generated magnetic field.

7. The 6-step/linear modulation hybrid control method according to claim 1, wherein performing the 6-step control for 3 phases while performing the linear modulation control for the remaining 3 phases comprises: performing, by the driver, Clarke transform in the linear modulation control to represent a 3-phase voltage as a 2-dimensional vector.

8. The 6-step/linear modulation hybrid control method according to claim 7, wherein performing the Clarke transform in the linear modulation control comprises:
determining, by the driver, a sector, in which vectors are disposed in a space-vector plane, based on the Clarke-transformed 2-dimensional space vectors; and
selecting, by the driver, two fixed vectors and a zero vector from the sector in which the vectors are disposed in the space-vector plane, thereby creating a voltage vector.

9. The 6-step/linear modulation hybrid control method according to claim 8, wherein selecting the two fixed vectors and the zero vector from the sector comprises:
calculating, by the driver, switching times of the two fixed vectors and the zero vector based on the created voltage vector;
generating, by the driver, a pulse width modulation signal in accordance with the calculated switching times, thereby controlling an inverter; and
controlling, by the inverter, a voltage of the motor using the generated pulse width modulation signal.

10. The 6-step/linear modulation hybrid control method according to claim 1, further comprising: upon determining that the calculated required torque does not exceed the predetermined torque, applying, by the controller, a signal to the driver to control the driver to perform linear modulation control for all 6 phases of the stator winding of the motor.

11. The 6-step/linear modulation hybrid control method according to claim 1, wherein, in performing the 6-step control for 3 phases while performing the linear modulation control for the remaining 3 phases when the hybrid modulation signal is applied to the driver, the driver outputs a maximum torque through execution of the 6-step control for the 3 phases among the 6 phases in order to satisfy the required torque, and then performs the linear modulation control for the remaining 3 phases, corresponding to a difference between an output maximum torque and the calculated required torque.
